(19) United States
(12) Patent Application Publication
(10) Pub. No.: US 2011/0032160 A1
(43) Pub. Date: Feb. 10, 2011

(54) BEARING, IN PARTICULAR ROLLER BEARING OR JOURNAL BEARING OR LINEAR GUIDE, WITH A TRANSPONDER

(75) Inventor: Thomas Rink, Waldfenster (DE)

Correspondence Address: LUCAS & MERCANTI, LLP, 475 Park Avenue South, New York, NY, 10016, US

(73) Assignee: SCHAEFFLER TECHNOLOGIES GMBH & CO. KG, Herzogenaurach (DE)

(21) Appl. No.: 12/937,895

(22) PCT Filed: Apr. 4, 2009
(86) PCT No.: PCT/DE09/00455

§ 371 Date: Oct. 14, 2010

(30) Foreign Application Priority Data
Apr. 15, 2008 (DE) 10 2008 018 776.3

(51) Int. Cl. H01Q 1/24; H01Q 13/10

(52) U.S. Cl. 343/702; 343/767

(57) ABSTRACT

A bearing, in particular a roller bearing or journal bearing or linear guide, which has at least one bearing component, in particular a bearing ring of the roller bearing, and a transponder with an antenna. Specifying a bearing, in particular a roller bearing or journal bearing, or a linear guide, with an RFID transponder that has an antenna for which the antenna of the RFID transponder is simple and is largely independent of the design of the bearing, is achieved in that the antenna is in the form of a slotted antenna and has a slot, and in that the slot is formed in or on the bearing component.

### FIELD OF THE INVENTION

The invention relates to a bearing according to the preamble of claim 1, in particular a roller bearing or friction bearing or a linear guide, with a transponder.

From practical experience it is known to assign RFID elements with transponders to bearings, in particular roller bearings or friction bearings, in order to store bearing-specific data and be able to retrieve it when necessary. For this purpose, the transponders comprise an antenna which is addressed by means of electromagnetic radiation and is arranged on or in the bearing. In this context, difficulties arise due to the screening of the electromagnetic radiation by the generally metallic components of the bearing, specifically the bearing rings of a roller bearing.

U.S. Pat. No. 6,501,382 B1 describes a roller bearing with an outer ring as a bearing component, in the body of which a bore, within which the RFID element is arranged, is provided on the end side of the outer ring. The antenna is structurally integrated into the RFID element. The antenna is screened here by the metallic surroundings of the inner face of the bore and can only be addressed with difficulty and signals which are emitted by the RFID element can only be received poorly outside the bearing ring.

DE 10 2004 005 234 T5 describes an arrangement of an RFID element on a roller bearing which has, as a bearing component, a sealing element with a metallic inlay. The generally annular, metallic inlay has a bore, wherein the sections of the metallic body of the inlay which remain between the bore are connected as an antenna of the RFID element. Here, in particular a dipole antenna, which is delimited on both sides by the bore, is formed. Since the ends of the dipole antenna lie very close to one another, the antenna only has a low power. It is also the case that such an arrangement cannot be used for bearings which do not have a sealing element or in which the sealing element does not have a metallic inlay.

Since the RFID element is arranged in a sealing element with a metallic inlay but the metallic inlay is not connected as an antenna of the RFID element (DE 10 2004 235 T5), the metallic inlay disrupts the function of the antenna which is integrated into the RFID element.

### OBJECT OF THE INVENTION

The object of the invention is to specify a bearing, in particular a roller bearing, friction bearing or a linear guide, with an RFID transponder with an antenna, for which the antenna of the RFID transponder is embodied in a simple way, largely independently of the embodiment of the bearing.

### SUMMARY OF THE INVENTION

According to the invention, this object is achieved for the bearing mentioned at the beginning by means of the features of claim 1.

The embodiment of the antenna as a slotted antenna only requires a slot to be formed in the body of the bearing component which is usually metallic anyway. Such a slot is easy to manufacture; if required, notches, grooves, bores or recesses such as blind bores, which are frequently provided during the manufacture of the bearing component, can be configured as a slotted antenna, and in particular connected as a slotted antenna for the transponder by means of a circuit. The slot may also be formed by virtue of the fact that a section of the body of the bearing component is bent or caulked, and by virtue of the fact that said section is approximating the surface of the same bearing component, or of another bearing component, so that a gap is formed which can be connected as a slot in a slotted antenna, without material removal of the body of the bearing component occurring during the construction of the slot.

Any slot on a body of a bearing component of a bearing can essentially be used as a slotted antenna of a transponder which is assigned to the bearing.

In terms of the arrangement of the slot on the body of the bearing component or of the geometric configuration of the slot there is a degree of freedom which can be utilized to optimize the antenna property of the slot. The slot may be constructed, for example, as a bore which penetrates the body of the bearing component or as a blind hole bore which is provided in the body. Furthermore, can assume essentially any geometric shape provided that the slot remains basically suitable as a slotted antenna. It is also possible to provide that the slot is arranged spatially separate from the transponder, if a suitable circuit is provided between the slot and the rest of the transponder. For example, it is possible that the slot is not provided on the bearing itself but rather on the bearing receptacle and that the rest of the transponder is arranged on a bearing ring, so that in this sense the bearing receptacle is considered to be a bearing component. Correspondingly, the slot may be provided on a bearing ring as a bearing component, and the transponder may be provided outside the bearing, for example on the bearing receptacle, provided that the slot is connected as a slotted antenna with respect to the rest of the transponder.

If the bearing is embodied as a roller bearing with an inner ring and an outer ring, the slot can be formed by the gap constructed by the inner ring and the outer ring, provided that the gap is configured in an electrically insulating fashion, for example if non-conductive, in particular ceramic roller bodies, are provided.

The connection of the slot as a slotted antenna of the transponder may be formed by a conductive connection, specifically by a galvanic connection between the slot and the rest of the transponder. Alternatively or additionally, it is possible to provide for the connection between the slot and the rest of the transponder to be embodied free of contact, specifically by means of a capacitive or inductive coupling of the slot to the rest of the transponder.

In terms of the geometric configuration of the slot there is preferably provision for the slot to be embodied as an essentially square recess. In this context, the slot is given a simple, easily reproducible shape which is favorable in terms of mass production. The parallel side faces of the square recess also permit the rest of the transponder to be addressed, in particular, with polarized radiation, and ensure that the signals which are emitted by the transponder have a polarization, so that these signals can easily be detected in a noise background.

If the slot is embodied as an essentially square recess, there is preferably provision for the square recess to have a long side face with a length which corresponds approximately to half the wavelength of the transponder, and a depth of approximately one quarter of the wavelength of the transponder. The dimensioning of the slot with respect to the wavelength to which the transponder responds ensures that the slot is tuned, as a slotted antenna, to the wavelength of the transponder. Other wavelengths are only weakly received by the slotted antenna, so that the slotted antenna can act as a filter.

The rest of the transponder can be arranged spaced apart from the slotted antenna.

However, there is preferably provision that the transponder is arranged in the slot. The slot constitutes an opening or a receptacle for the rest of the transponder which is at least partially filled by the transponder. The transponder may, in particular, be accommodated in the slot in such a way as to ensure that the transponder does not protrude beyond the slot. Specifically, the slot may be configured in such a way that it accommodates the rest of the transponder but the surfaces or edges of the slot which produce its effect as a slotted antenna are optimized in such a way that the slot can be connected as a good slotted antenna of the transponder.

There is preferably provision that the transponder is arranged off-center in the slot, in particular near to a face of the slot. Given the off-center arrangement, the rest of the transponder can be arranged at a location at which the input impedance of the slotted antenna, which is essentially determined by the geometric shape of the slot, the arrangement of the rest of the transponder in the slot and the dielectric properties of the slot, is adapted to the rest of the transponder.

If the slot is formed by an essentially square recess in the body of the bearing component, wherein a long side face of the square corresponds approximately to half the wavelength, and a depth of the square, measured from the surface of the surroundings of the recess, corresponds to approximately a quarter of the wavelength of the transponder, it is preferably possible to provide that the transponder is arranged in the slot near the short side face of the square. It is furthermore possible to provide that the long side face, or the short side face, of the square or the bottom face itself has an opening, the face is small with respect to the face of the side face or bottom face, wherein the transponder is at least partially accommodated in this opening.

There is preferably provision that the slot is filled with a dielectric. The dielectric increases the energy density in the slot and furthermore provides the possibility of setting the wavelength in the slot, specifically in such a way that the input impedance of the rest of the transponder is tuned to the impedance of the slotted antenna.

Preferably, there is provision that the antenna is embodied as a structural unit comprising a connection for the transponder, a dielectric which surrounds the connection of the transponder, and an electrically conductive, external coating of the dielectric. This structural unit can be fitted, as a module which is produced separately from the bearing, into a receptacle which is provided in the bearing component. Such a structural unit may also be provided as a slotted antenna in cases in which the body of the bearing component is not embodied in a metallically conductive fashion. The electrically conductive coating of the dielectric forms here the inner faces of a slot and therefore the effective faces or edges of the slotted antenna. The dielectric itself stabilizes the faces of the slot mechanically and brings about defined electrical conditions between the faces of the outer coating. The connection of the transponder permits the structural unit to be connected as a slotted antenna for a transponder which may be arranged outside the structural unit, but is preferably a component of the structural unit and is accommodated within the dielectric or on the dielectric.

If the antenna is configured as a structural unit, there is preferably provision that the electrically conductive, external coating of the dielectric is surrounded by a non-conductive coating, in particular a ceramic coating. The ceramic coating screens the structural unit in electronic terms from the body of the bearing component, in particular mechanical, thermal or magnetic influences of the body of the bearing component on the structural unit can be controlled. The ceramic coating may have the electrically conductive outer coating as an internal coating which then in turn surrounds the dielectric. In this case, the ceramic coating is part of the structural unit.

As an alternative to a prefabricated structural unit as a slotted antenna, it is possible to provide a slot in the body of the bearing component, to provide the inner face of the slot with a dielectric coating, for example by attaching a ceramic foil, to apply an electrically conductive face to the dielectric coating, for example by attaching a metallic foil to the dielectric coating, specifically the ceramic foil, and to position at least the connection of the transponder to the slotted antenna, preferably all of the rest of the transponder including the connection to the slotted antenna, in the inner face of the slot which is lined in this way. If required, the region which is surrounded by the inner face of the slot can be filled with a dielectric whose surface terminates flush with the edge of the slot in the plane of the body of the bearing component.

Further advantages and features of the invention emerge from the description of a preferred exemplary embodiment and from the dependent claims.

The invention will be described and explained in more detail below with reference to the appended drawings.

### BRIEF DESCRIPTION OF THE DRAWINGS

FIG. 1 shows a cross section through a detail of an exemplary embodiment of a bearing according to the invention,

FIG. 2 shows the detail from FIG. 2 in a plan view, and

FIG. 3 is a schematic, perspective view of a slotted antenna which differs from the slotted antenna shown in FIGS. 1 and 2.

### DETAILED DESCRIPTION OF THE DRAWING

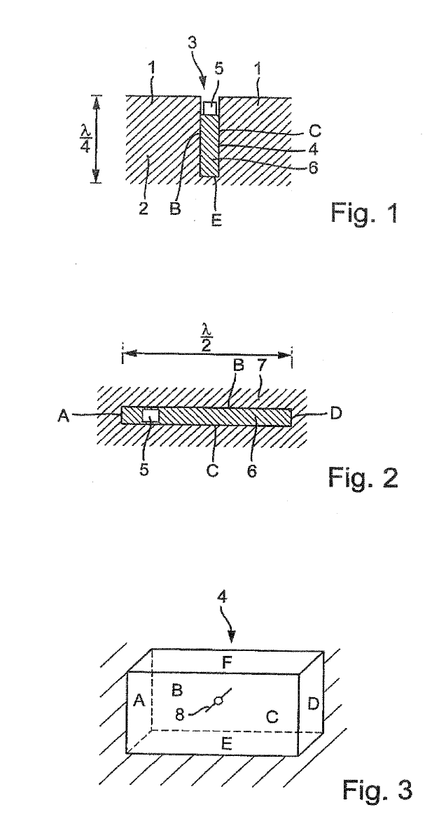

FIG. 1 shows a bearing which is embodied as a roller bearing or friction bearing, having a bearing component 1, specifically a bearing ring of a roller bearing, in the body 2 of which a transponder 3 is arranged. The bearing may also be embodied as a linear guide, and the bearing component 1 is then a component of the linear guide. The transponder 3 comprises an antenna which is embodied as a slotted antenna 4, and the rest of the transponder 5, which accommodates, in particular, electronic storage components. The slotted antenna 4 is embodied as an antenna of the transponder 3 and is coupled to the rest of the transponder 5, in particular coupled in a contactless fashion, specifically by an inductive or capacitive coupling.

The slotted antenna 4 is embodied as a slot 6 in the body 2 of the bearing component 1; this slot 6 has, with respect to the surface 7 of the region of the body 2 of the bearing component 1 which region is adjacent to the slot 6, a depth of a quarter of the wavelength, to which the transponder 3 is tuned and with which the transponder 3 transmits, or can be addressed from the outside by an operator.

The slot 6 is of narrow design in the sense that its extent in the plane of the surface 7 of the body 2 is significantly smaller than its depth. Within the slot 6, the rest of the transponder 5 is arranged near to the surface of the slot 6, that is to say off center. The slot 6 is filled with a dielectric which extends as far as the surface of the slot 6 and within which the rest of the transponder 5 is arranged, and which terminates essentially flush with the surface 7 of the body 2. Side walls B, C extend essentially perpendicularly from the surface 7; the slot also comprises a bottom face E. The body 2 of the bearing component 1 is electrically conductive, in particular metallic, so that the side walls B, C of the slot 6 form conductive boundary faces with the dielectric between the side walls B, C. As a result, the side walls B, C can be embodied as conductive faces or edges of the slotted antenna 4 by means of suitable wiring.

FIG. 2 shows the slot 6 and the surface 7 of the body 2 in a plan view. Compared to FIG. 1, it is apparent that the slot 6 is embodied in its entirety as an essentially square recess in the body 2. The long side faces B, C of the square have an extent which corresponds essentially to half the wavelength of the transponder 3. It is also apparent that the rest of the transponder 5 is accommodated off center in the dielectric in the slot 6, in particular displaced towards one of the short side faces A, D.

Since the slotted antenna 4 is formed by the long side faces C, B, the precise configuration of the short side faces A, D or of the bottom face B is not decisive for the functioning of the slotted antenna 4. In particular, the side faces A, D can also be of rounded configuration or be dispensed with entirely, so that in the latter case the long side faces C, B approach one another towards the respective ends, and the slot 6 forms an essentially almond-shaped plan view. Likewise, the bottom face B can be of rounded design or end in a V shape. At the ends, the slot can also widen in the region of the side face A, D so that the rest of the transponder 5 can be accommodated in this widened portion of the slot. Furthermore, the bottom surface B or one of the two side faces C, B or A, D can have a depression in which the rest of the transponder 5 is accommodated so that the latter is no longer located directly between the long side faces C, B.

The slotted antenna 4 which is shown in FIG. 3 differs from the slotted antenna illustrated in FIG. 1 or FIG. 2 in so far as the rest of the transponder 5 is arranged centrally in the slot 6 which is formed as a square recess. Galvanic contacts 8 project from the rest of the transponder 5 to the two long side faces B, C of the slot 6. The side faces A, B, C, D, E of the slotted antenna 4 are not conductive on the outside, in particular are provided with a ceramic coating, and are of electrically conductive design on the inside, on the partial face facing the rest of the transponder 5. The ceramic coating insulates the slotted antenna 4 from the body 2 of the bearing component 1. The slotted antenna 4 is also filled with a dielectric (for example PA66-GF25 or a ceramic from which roller bodies are formed) within which the rest of the transponder 5 is arranged with the connection to the side faces B, C of the slotted antenna, specifically with the contact 8 to the side faces B, C.

The slotted antenna 4 which is illustrated in FIG. 3 may be embodied as a structural unit which comprises, as components, at least the electrically conductive partial faces of the side faces B, C, the dielectric and the connections of the rest of the transponder 5 to the electrically conductive partial faces of the side faces B, C. Such a structural unit can be inserted into a recess of square shape. If the structural unit additionally has an external ceramic or non-conductive coating, this structural unit can be used as a slotted antenna largely independently of the electrical conductivity of the body 2 of the bearing component 1.

In the exemplary embodiment described above, the slotted antenna 4 was formed, in particular, by the long side faces C, B of the slot 6. It goes without saying that alternatively or additionally the short side faces A, D can also be connected as a slotted antenna which is tuned to another wavelength of the transponder 3. It also goes without saying that the faces of the slotted antenna do not necessarily have to be located opposite one another; these faces can also include an angle with one another. For example, it is possible to provide that the slotted antenna is formed between a short side face, for example A, and a long side face, for example B, provided that electrical insulation is provided between the side faces A and B.

In the exemplary embodiment described above, the geometric shape of the slotted antenna 4 was determined essentially by the shape of the slot 6. In so far as a slot has a shape which differs from the desired slotted antenna 4, it goes without saying that the slot can be adapted in its shape to the desired shape of the slotted antenna 4, in particular the slot can be filled to such an extent with, for example, electrically conductive paste until the remaining gap has the desired geometric shape of the slotted antenna. If the slotted antenna 4 is formed by a structural unit, this structural unit may be inserted into the filling of the slot, specifically into the electrically conductive paste.

In the exemplary embodiment described above, the slot was embodied as a recess in the body 2 of the bearing component 1. It goes without saying that the slot does not have to be provided as a recess in the body; likewise it is possible to provide for the slot to be formed between the surface 7 of the body 2 and a section which is caulked with respect to the surface 7. Furthermore, the slot may be formed between the surface of a first bearing component and the surface of a second bearing component, in particular between the inner ring and the outer ring of a roller bearing or between a bearing ring and an electrically conductive sealing element of the bearing.

In the exemplary embodiment described above, the slot 6 was formed by a blind bore in the body 2 of the bearing component 1. It goes without saying that the slot 6 can also be formed by a breakthrough which penetrates the body 2 and in which there is no bottom face E.

The side faces A, B, C, D, E of the slotted antenna 4 of the exemplary embodiment from FIG. 3 were not conductive on the outside, and were in particular provided with a ceramic coating. It goes without saying that the side faces can also be of conductive design on the outside.

The invention has been described above with reference to a bearing which is embodied as a roller bearing. The bearing component 1 was here the cage, the seal, one of the roller bodies or one of the bearing rings of the roller body. It goes without saying that the bearing may also be embodied as a linear guide, and that in this case the rail, the revolving unit or the carriage or some other part of the linear guide corresponds, as a bearing component, to the bearing component 1 of the two exemplary embodiments described above.

### LIST OF REFERENCE NUMERALS

1 Bearing component
2 Body of the bearing component 1
3 Transponder
4 Slotted antenna of the transponder
5 Rest of the transponder
6 Slot
7 Surface of the body 2
8 Galvanic contact

1. A bearing, comprising:
at least one hearing component; and
a transponder with an antenna,
wherein the antenna is a slotted antenna and comprises a slot, and
wherein the slot is embodied in or on the bearing component.

2. The bearing as claimed in claim 1, wherein the slot is an essentially square recess.

3. The bearing as claimed in claim 2, wherein the square recess has a long side face with a length which corresponds to approximately half a wavelength of the transponder, and a depth of approximately one quarter of the wavelength of the transponder.

4. The bearing as claimed in claim 1, wherein a rest of the transponder is arranged in the slot.

5. The bearing as claimed in claim 4, wherein the rest of the transponder is arranged off center in the slot, near to a surface of the slot.

6. The bearing as claimed in claim 1, wherein the slot is filled with a dielectric.

7. The bearing as claimed in claim 1, wherein the antenna is a structural unit comprising a connection for the transponder, a dielectric which surrounds the connection of the transponder, and an electrically conductive, external coating of the dielectric.

8. The bearing as claimed in claim 7, wherein the electrically conductive, external coating of the dielectric is surrounded by a non-conductive coating.

9. The use of a slot in or on a bearing component of a bearing as a slotted antenna of a transponder which is assigned to the bearing.

10. The bearing as claimed in claim 1, wherein the bearing component is a bearing ring.

11. The bearing as claimed in claim 8, wherein the non-conductive coating is a ceramic coating.
